(19) United States
(12) Patent Application Publication
(10) Pub. No.: US 2006/0086580 A1
(43) Pub. Date: Apr. 27, 2006

(54) Device for shock absorption by means of piezoelectric actuators

(76) Inventors: Maximilian Fleischer, Hohenkirchen (DE); Reinhard Freitag, Munchen (DE); Hans Meixner, Haar (DE)

Correspondence Address: YOUNG & THOMPSON, 745 SOUTH 23RD STREET, 2ND FLOOR, ARLINGTON, VA, 22202, US

(21) Appl. No.: 10/515,323

(22) PCT Filed: May 22, 2003
(86) PCT No.: PCT/DE03/01657

§ 371 Date: Aug. 29, 2005

(30) Foreign Application Priority Data
May 24, 2002 (DE) 102 23 216.4

(51) Int. Cl. F16F 9/512

(52) U.S. Cl. 188/266.1; 188/322.13; 188/299.1; 188/266.7

(57) ABSTRACT

A connection between a piezoelectric stack/actuator and a mobile object in a damping mechanism. The connection is embodied in such a way that a cross-section of the object expands via electrical control of the piezoelectric stack or the width of through-openings in the object varies, enabling the width of a passage for the liquid contained in the damping housing to be determined. The invention is advantageous in that a plurality of embodiments can be achieved as a result of the fundamentally simple inventive device, but basically in that a significantly improved reaction time and variability of the damping properties are ensured as a result of an especially simple device.

The invention relates to a damping mechanism that is adaptive to varying shocks.

Damping mechanisms are used in many fields of technology in situations where varying forces exerted on an object place severe stress on the integrity of the material of said object. Examples include wheels on a motor vehicle or aircraft, a seat or a seat pan in a motor vehicle or aircraft or other objects which are subjected to sudden accelerations, such as gun barrels, for example.

Protection for a sensitive cargo can essentially be ensured by means of a damping mechanism which will absorb the forces which would otherwise stress the cargo.

A shock absorber mainly consists of a cylindrical housing filled with a fluid, e.g. a liquid or a gas, which is set in motion or pressurized by a piston. The piston moves up and down along the main axis of the cylinder in such a way that the fluid contained in the cylindrical housing can flow through an adjustable passage space, such as the space between the inner wall of the cylindrical housing and the outer enclosing edge of the piston.

The damping characteristics can be approximately varied by regulating the viscosity of the fluid or the width of the passage space. It is quite practicable to combine these methods. It is therefore possible to determine how far the damper gives way in the cylinder within a given time.

Adaptive damping characteristics are an extremely important extension of the above principle. For example, the damping for sports use of a motor vehicle would generally have to be harder than the softer damping required for normal use of a vehicle.

The need arises to vary the damping characteristics of a damper even during operation of an object and to optimize it for a part to be protected. The increased density of forces in different directions to be expected at high velocities calls for the use of electronically controllable dampers, as they provide much quicker reaction times than using hydraulic damping regulation.

The profile of a road to be driven over can be detected e.g. by sensors, this information first being used to control the vehicle's damping. The damper must be capable of changing the damping within a very short time (ranging e.g. from a few ms down to a few 10 μs).

There are currently two usual systems for varying the width of the passage space for a fluid in a damper housing:

A first method consists of varying the passage space for the damping fluid with the aid of an electromagnetic damper adjusting device, a kind of “solenoid valve” which opens in varying degrees to enlarge the flow cross-section.

The disadvantage of this method or device is that for many damping tasks an excessively long operate or reaction time is required, which is further limited by the magnetization of the coil.

Another second method consists of implementing the change in the viscosity of the damper fluid using so-called electro- or magnetorheological fluids, in contrast to normal hydraulic fluids such as oil. In the case of a magnetorheological fluid, the viscosity change is achieved by means of the properties of suspended fine magnetic particles which are exposed to an electric field, the field being controlled at the passage space of the piston in such a way that dipoles are formed along the field lines, resulting in the viscosity of the fluid being increased by about an order of magnitude. This process is reversible, the reaction times likely to be in the millisecond range. Thus the flow of the fluid through the passage space can be controlled in the range of an order of magnitude.

The disadvantage of this method is in particular the temperature dependence of the fluid viscosity, the high price of the fluid, the abrasion of the restrictor opening by the particles and the risk of the particles settling after a lengthy period of inactivity.

The object of the invention is therefore to specify a shock absorption mechanism in which an extremely fast reaction time and optimum damping is achieved for different shocks.

This object is achieved by the features set forth in claim 1. Preferred developments will emerge from the subclaims.

The essence of the invention is that a connection between a piezoelectric stack/actuator and a movable object in a damping mechanism is implemented in such a way that a cross-section of the object expands due to electrical activation of the piezoelectric stack or the width of orifices in the object is varied, thereby enabling the width of a passage space for the fluid contained in the damper housing to be determined.

The invention is therefore advantageous in that a plurality of embodiments can be achieved as a result of the fundamentally simple arrangement of the invention, but basically in that a significantly improved reaction time and variability of the damping properties are ensured as a result of a particularly simple device.

In the device according to the invention for controlling a fluid flow in a damping mechanism, the passage of a fluid between a piston and the inside of the damper housing is regulated by determining the size of the cross-section of the piston or the expansion of part of the object by applying an electrical voltage to the piezoelectric actuator.

The piezoelectric actuator is in direct mechanical connection with the piston.

In a preferred development of the invention, the piezoelectric actuator can be accommodated in the space of a piston in which cross-section regulation takes place.

Alternatively, the piezoelectric actuator can be outside the cross-section regulation space, e.g. in the piston skirt.

It is basically preferred that the object in the way of the fluid, e.g. an extension of the piston, is a hollow double cone, the maximum cross-section of the hollow double cone being between the upper and the lower half of the hollow double cone.

Alternatively, the object in the way of the fluid can also be cylindrical, the object having at least one variable orifice.

In the method for controlling an orifice for a fluid or a gas in a housing by means of a movable object, a piezoelectric stack is caused to expand by means of electrical activation. The piezoelectric stack is connected to the object in such a way that the orifices for the fluid can be varied.

The cross-section of the object or one or more opening widths of orifices in the object itself can be varied.

In a particularly important extension of the invention, the piezoelectric stack is held under pretension and therefore protected from external shocks and damaging tensile stresses. The pretensioning can be achieved by accommodating the piezoelectric stack in a pretensioned hollow double cone or a pretensioned tubular spring.

The invention and further advantages will be explained in greater detail in the drawings and in the exemplary embodiments and arrangements illustrated, in which.

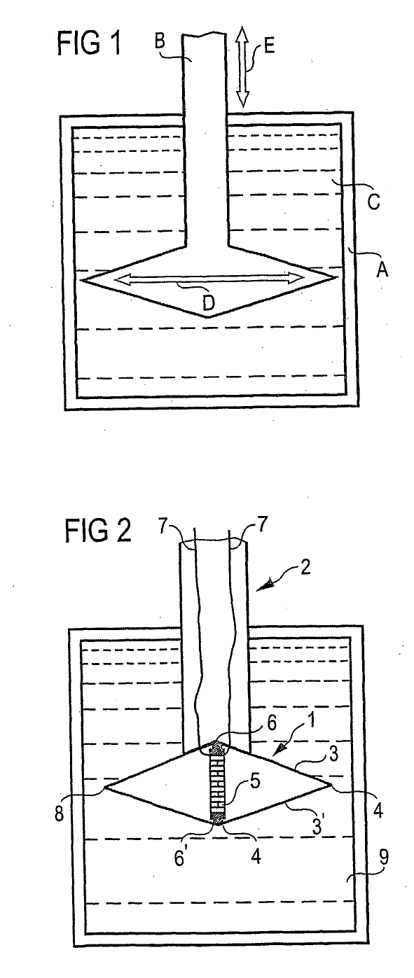

FIG. 1 shows a basic embodiment of an adaptive damper in which the cross-section of a double cone piston is variable, and

FIG. 2 shows a shock absorber according to FIG. 1 with inbuilt piezoelectric stack and electrical connection, and

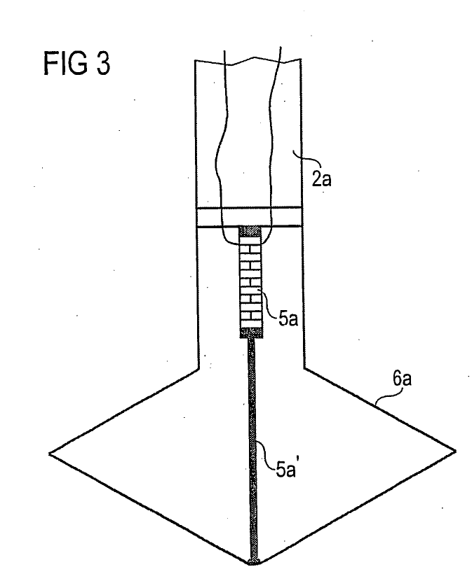

FIG. 3 shows a shock absorber according to FIG. 2 in which the piezoelectric actuator is accommodated in the piston skirt and the cross-section of the double cone piston is variable by means of a circular cone, the maximum expansion of the cross-section being achieved by minimum voltage, and

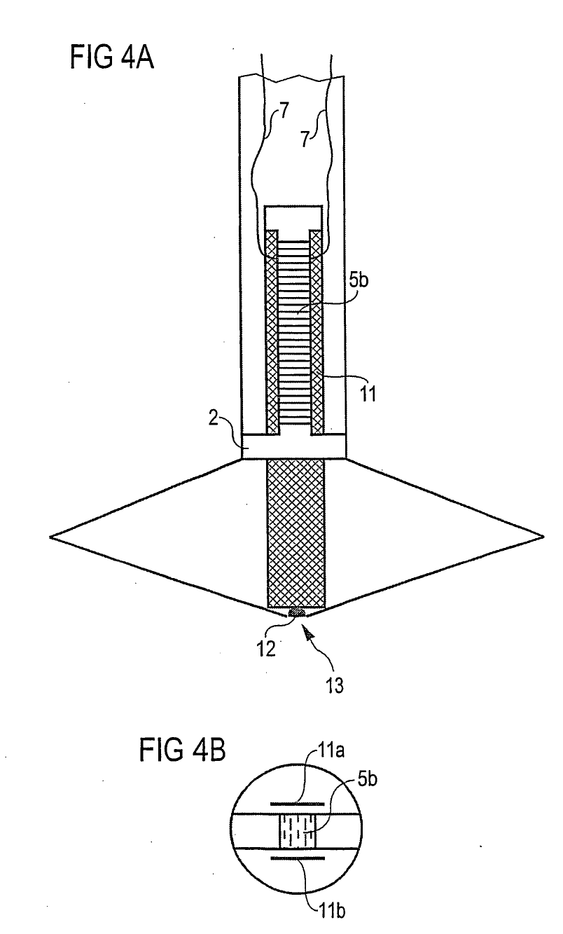

FIG. 4 shows a shock absorber according to FIG. 3 in which the maximum expansion of the cross-section is achieved by maximum voltage, and

FIG. 5 shows a shock absorber according to FIG. 4 having a cylindrical piston with two orifices controllable by piezoelectric actuators, and

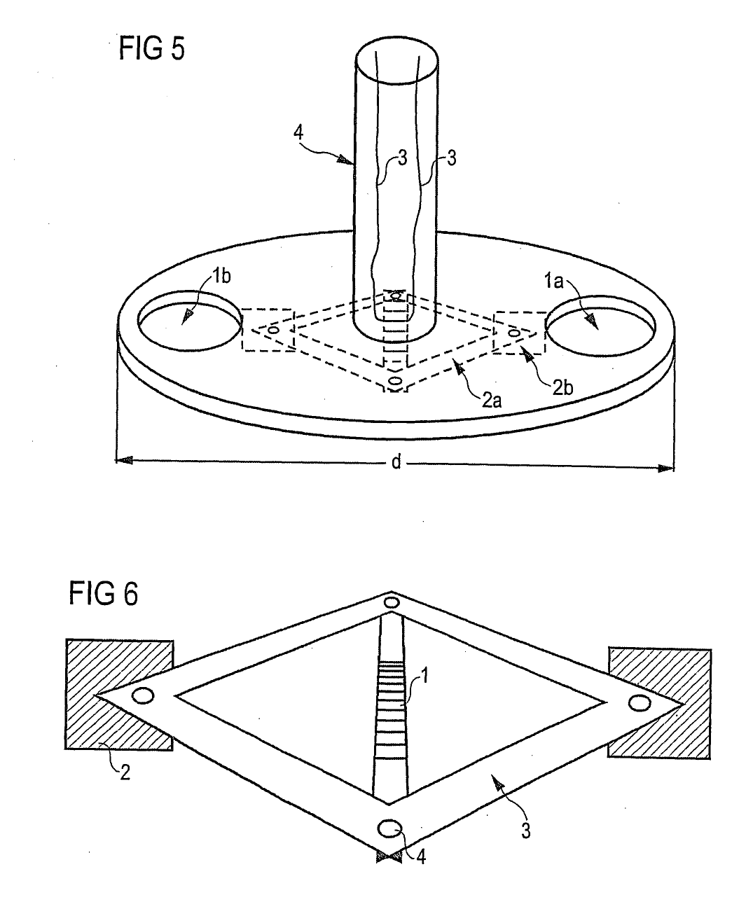

FIG. 6 shows a device for passage regulation according to FIG. 5.

FIG. 1 shows a basic embodiment of a shock absorber, where A denotes the wall thickness of the piston housing, B the piston itself, C the oil in the housing and D a double cone piston or the variation of its cross-section. The direction of movement of the piston is shown by the arrows E.

FIG. 2 shows an adaptive damper according to the principle of cross-section variation of an orifice in which, however, this variation is not achieved using an electromagnetic valve but by deformation of the piezoelectric stack particularly suited for this purpose, said piezoelectric stack consisting of a plurality of piezoceramic layers. When an electrical voltage is applied to the piezoelectric stack or to a piezoceramic layer, the height of the piezoceramic layer expands. This expansion propagates through the remaining layers, thereby causing the entire piezoelectric stack to expand. The orifice can be varied by means of a connection between the piezoelectric stack and a cross-section regulator.

The piston 2 is implemented and extended as a hollow double cone 1, i.e. two cones 3 and 3′ placed one on top of the other whose generating lines are interconnected at the respective bases of the individual cones. The cones 3 and 3′ can be welded together at the points 4 or 8. In the double cone 1, a piezoelectric stack 5 is installed in the double cone axis in such a way that its end points are connected to the cone apexes 6 and 6′ in the direction of the longitudinal axis of the housing. If the piezoelectric stack 5 lengthens due to an electrical voltage or current being applied through the supply lines 7, the cone apexes 6 move apart along the double axis in such a way that the largest diameter of the double cone constituting the sealing surface of the damper piston is made smaller and more fluid can flow past the piston 2 so that the damping is reduced.

It should be noted that the piezoelectric stack basically expands in one direction only when electrically activated. Tensile stresses which are produced, for example, when a vehicle is being driven, particularly over uneven terrain, can have a damaging effect on the piezoelectric stack. In order to protect the piezoelectric stack from damaging impacts of this kind, it is preferred that the piezoelectric stack be incorporated in a tubular spring (not shown) and kept under permanent compression by this spring. If the double cone 6 is pretensioned by welding together, the tubular spring's function of protecting the piezoelectric actuator can alternatively be dispensed with and the protection function can be assumed by the double cone.

In order to maximize the elasticity of the double cone piston 1, the wall of the cone is made as a thin as possible. This allows maximum expansion of the piston cross-section which is also governed by the diameter of the piston housing. However, in order to compensate for the stability lost as a result of this measure, the cone surface is advantageously reinforced between apex 6′ and sealing surface, i.e. position of the largest cross-section variation 4 or 8, by engraved ribs or beads, welded rods or other material reinforcements, e.g. like the spokes an umbrella, on one or both sides of the double cone 6. The material of the double cone can be selected according to rigidity, cost, strength and/or weight. The double cone could consist, for example, of metal or a fiber-reinforced plastic.

The extent of the maximum cross-section of the double cone 6 is preferably of circular form, as a circular cross-section of the double cone 6 in particular can be optimally changed, which would not be the case with other geometries.

The choice of the relationship between the height of the double cone piston and its diameter defines the ratio of the damping for no-voltage piezoelectric stack/actuator to the damping for activated piezoelectric stack/actuator. The variation ratio can also be controlled by selecting the absolute diameter of the piston housing and the difference between the internal diameter of the cylinder and the external diameter of the piston.

FIG. 3 shows a device employing the principle according to FIG. 2 but in which the piezoelectric stack 5a is accommodated outside the hollow double cone 6a, preferably in the housing of the shock absorber 2a.

In this exemplary embodiment, the maximum expansion of the double cone cross-section is achieved by the piezoelectric actuator 5a via a rod 5a′ connected to the piezoelectric stack in a position of rest, i.e. without electrical activation, thereby achieving maximum damping.

In FIG. 4a, conversely to FIG. 3, maximum damping is achieved by displacement of the piezoelectric stack 5b and minimum damping by the position of rest of the piezoelectric stack. The position of rest, i.e. without electrical activation, of the piezoelectric stack is to be seen such that the lower apex of the double cone 13 is pulled away from the piezoelectric stack or pushed away from the piezoelectric stack. A smaller cross section of the double cone piston is therefore ensured. When the piezoelectric stack is displaced by electrical activation via the supply lines 7, the piezoelectric stack is lifted in the direction of the piston skirt 2 by means of strips 11a and 11b from FIG. 4b behind the stack. The force of the piezoelectric stack 12 can be introduced via a circular cone. An expansion of the double cone cross-section, causing increased damping to be achieved, is therefore possible.

In FIG. 5, instead of a double cone, a circular cylinder is used for which the outermost dimension d extends to the inner wall of the damper housing, but the cylinder has orifices 1a and 1b perpendicular to the piston axis which are opened and closed by a slider frame 2a and therefore by sliders 2b controllable by piezoelectric actuators, said piezoelectric actuator being supplied via the connection 3 which can be accommodated in the piston 4, for example.

FIG. 6 shows the sliding mechanism used in the embodiment according to FIG. 5. The piezoelectric actuator 1 lies perpendicular to the piston axis. Its electrical activation and subsequent expansion causes a displacement of the slider frame 3 which varies the cross-section of the orifices according to FIG. 5 by means of the sliders 2, the slider frame preferably being parallelogram- or rhombus-shaped, and movable connections 4 between the edges of the slider frame 3 allowing movement of the sliders 2 toward and away from one another.

Control of the orifices can basically be achieved by means of a connection with sensors which send suitable electrical signals to the piezoelectric stack of the damping mechanism according to the invention. The signals would first be processed by an evaluation unit. This evaluation unit can typically have a processor, a memory and a stored program product.

For example, the terrain in front of a vehicle could be scanned by means of the sensors and correlated with the speed of the vehicle in such a way that the piezoelectric stack is activated at a point in time when the vehicle is just driving over an obstacle. Further embodiments of this kind are also of interest for aircraft during a turbulent phase of a flight.

A further embodiment of the invention would permit manual activation of the damping characteristics. This possibility would be of interest for comparatively long off-road or freeway sections.

1. A device for passage control of a fluid or gas in a housing by means of a movable object, wherein
at least part of the object can be expanded to the extent that a variation of a passage space for the fluid in the housing is controllable,
a piezoelectric stack is mechanically connected to the object in such a way that the cross-section of the object or the expansion of part of the object is controllable by means of the expansion of the piezoelectric stack,
the piezoelectric stack can be activated on the basis of electrically supplied electrical signals.

2. The device according to claim 1, wherein the passage space is between the object and the inside of a housing or the passage space is part of the object.

3. The device according to claim 1, wherein the object is an extension of the piston.

4. The device according to claim 2, wherein the object is a hollow double cone.

5. The device according to claim 1, wherein the supply lines are accommodated in the piston skirt.

6. The device according to claim 4, wherein the piezoelectric stack is accommodated in the hollow double cone.

7. The device according to claim 5, wherein the ends of the piezoelectric stack are each in mechanical connection with the upper and lower apex of the hollow double cone.

8. The device according to claim 4, wherein the piezoelectric stack is accommodated outside the hollow double cone and is in mechanical connection with the hollow double cone.

9. The device according to claim 1, wherein the object is cylindrical and has at least one variable orifice whose opening width is controllable by the piezoelectric stack.

10. The device according to claim 1, wherein the piezoelectric stack is accommodated in an additional pretensioned housing.

11. The device according to claim 10, wherein the housing is a pretensioned hollow double cone.

12. The device according to claim 10, wherein the housing is a pretensioned tubular spring.

13. A method for controlling an orifice for a fluid or gas in a housing by means of a movable object, wherein
a piezoelectric stack is caused to expand via electrical activation,
the piezoelectric stack is connected to the object in such a way that the orifice for the fluid is varied.

14. The method according to claim 13, wherein the piezoelectric stack is held pretensioned and is therefore protected from external impacts and/or damaging tensile stresses.

15. The method according to claim 13, wherein the cross-section of the object is varied.

16. The method according to claim 13, wherein the opening widths of the orifices in the object are varied.

17. The device according to claim 2, wherein the object is an extension of the piston.

18. The device according to claim 2, wherein the object is cylindrical and has at least one variable orifice whose opening width is controllable by the piezoelectric stack.
